(19) United States
(12) Patent Application Publication
(10) Pub. No.: US 2008/0240146 A1
(43) Pub. Date: Oct. 2, 2008

(54) System and method for wireless communication of uncompressed video having data transmission on a secondary low rate channel

(76) Inventors: Harkirat Singh, Santa Clara, CA (US); Huai-Rong Shao, San Jose, CA (US); Chiu Ngo, San Francisco, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/729,288

(22) Filed: Mar. 27, 2007

(51) Int. Cl. H04L 12/43

(52) U.S. Cl. 370/458

(57) ABSTRACT

A system and method for performing medium access control in a system for wireless communication of uncompressed video is disclosed. In one aspect, the system includes one or more high rate channels overlapping with a primary low rate channel and one or more secondary low rate channels. In another aspect, the system includes a communication device configured to communicate a bandwidth request message identifying bandwidth required for communication with another communication device. The bandwidth request message contains information allowing a device coordinator to determine a reserved time slot for communication on a secondary low rate channel when communication is determined not to be possible on a high rate channel. Transmission on the secondary low rate channel is time division duplexed with a high rate channel, where transmission at any one time can take place on either the high rate or the secondary low rate channel.

### BACKGROUND OF THE INVENTION

1. Field of the Invention

The present invention relates to wireless transmission of video information, and in particular, to transmission of uncompressed video information over wireless channels.

2. Description of the Related Technology

With the proliferation of high quality video, an increasing number of electronic devices, such as consumer electronic devices, utilize high definition (HD) video which can require multiple gigabit per second (Gbps) in bandwidth for transmission. As such, when transmitting such HD video between devices, conventional transmission approaches compress the HD video to a fraction of its size to lower the required transmission bandwidth. The compressed video is then decompressed for consumption. However, with each compression and subsequent decompression of the video data, some data can be lost and the picture quality can be reduced.

The High-Definition Multimedia Interface (HDMI) specification allows transfer of uncompressed HD signals between devices via a cable. While consumer electronics makers are beginning to offer HDMI-compatible equipment, there is not yet a suitable wireless (e.g., radio frequency) technology that is capable of transmitting uncompressed HD video signals. Wireless local area network (WLAN) and similar technologies can suffer interference issues when several devices are connected which do not have the bandwidth to carry the uncompressed HD signals.

### SUMMARY OF CERTAIN INVENTIVE ASPECTS

The system, method, and devices of the invention each have several aspects, no single one of which is solely responsible for its desirable attributes. Without limiting the scope of this invention as expressed by the claims which follow, its more prominent features will now be discussed briefly. After considering this discussion, and particularly after reading the section entitled “Detailed Description of Certain Embodiments” one will understand how the sample features of this invention provide advantages that include faster channel acquisitions, improved error recovery and improved efficiency.

One aspect is a method of performing link control in a system for wireless communication of uncompressed video, wherein the system comprises a plurality of low rate channels and one or more high rate channels. The method of this aspect includes receiving a bandwidth request message over a first low rate channel from a first device, the bandwidth request message comprising a minimum bandwidth request, determining a capability of the first device to utilize the high rate channel of the network, and in response to determining that the requesting first device cannot utilize the high rate channel, selecting one of the low rate channels and determining one or more available time slots on the selected low rate channel that satisfies the minimum bandwidth request, wherein the one or more high rate channels are used for communication of uncompressed digital video.

Another aspect is a device for performing link control in a system for wireless communication of uncompressed video, wherein the system comprises a plurality of low rate channels and one or more high rate channels. The device of this aspect includes a receiver to receive a bandwidth request message over a first low rate channels from a first device, the bandwidth request message comprising a minimum bandwidth request, and a link controller to determine a capability of the first device to utilize the high rate channel of the network, and in response to determining that the requesting first device cannot utilize the high rate channel, selecting one of the low rate channels and determining one or more available time slots on the selected low rate channel that satisfies the minimum bandwidth request, wherein the one or more high rate channels are used for communication of uncompressed digital video.

Another aspect is a method of performing medium access control in a system for wireless communication of uncompressed video, wherein the system comprises a plurality of low rate channels and one or more high rate channels. The method of this aspect includes transmitting a bandwidth request message over a first low rate channel, the bandwidth request message comprising a minimum bandwidth request, receiving a plurality of messages over the first low rate channel, determining that one of the received messages is a bandwidth response message associated with the transmitted bandwidth request message, the bandwidth response message containing information identifying a selected low rate channel and at least one reserved time slot within a superframe period, the superframe period being of a predetermined length, and subsequent to determining that one of the received messages is associated with the transmitted bandwidth request message, transmitting and/or receiving over the selected low rate channel during the at least one identified time slot of one or more subsequent superframe periods.

Another aspect is a device for performing medium access control in a system for wireless communication of uncompressed video, wherein the system comprises a plurality of low rate channels and one or more high rate channels. The device of this aspect includes a transmitter to transmit a bandwidth request message over a first low rate channel, the bandwidth request message comprising a minimum bandwidth request, a receiver to receive a plurality of messages over the first low rate channel, and a medium access controller configured to determine that one of the received messages is a bandwidth response message associated with the transmitted bandwidth request message, the bandwidth response message containing information identifying a selected low rate channel and at least one reserved time slot within a superframe period, the superframe period being of a predetermined length, wherein, subsequent to determining that one of the received messages is associated with the transmitted bandwidth request message, the transmitter transmits and/or the receiver receives over the selected low rate channel during the at least one identified time slot of one or more subsequent superframe periods.

Another aspect is a system for wireless communication of uncompressed digital video data over a wireless communication link, the wireless communication link including one or more high rate channels associated with a bandwidth capable of supporting transmission of the uncompressed video data, and a plurality of low rate channels comprising second bandwidths smaller than the first bandwidth, wherein at least a portion of a frequency band of each of the low rate channels overlaps a portion of a frequency band of one of the high rate channels. The system of this aspect includes a device coordinator including a receiver to receive a request for an available bandwidth over the low rate channel, a medium access controller configured to determine a capability to utilize the high rate channel, and, in response to determining the high rate channel cannot be utilized, select one of the low rate channels and determine a time slot available on the selected low rate channel that satisfies the bandwidth request, and a transmitter to transmit a response message over the low rate channel containing information identifying the determined time slot and the low rate channel. The system further includes a device including a transmitter to transmit the request for an available bandwidth over the low rate channel, and a receiver to monitor the low rate channel and to receive the response message, wherein the transmitter is further configured to transmit on the low rate channel during the identified time slot.

### BRIEF DESCRIPTION OF THE DRAWINGS

FIG. 1 is a functional block diagram of a wireless network that implements uncompressed HD video transmission between wireless devices according to one embodiment of the system and method.

FIG. 2 is a functional block diagram of an example communication system for transmission of uncompressed HD video over a wireless medium, according to one embodiment of the system and method.

FIGS. 3a and 3b are frequency maps of examples of overlapping high rate and low rate channels that may be used in a wireless network such as illustrated in FIG. 1.

FIGS. 4a and 4b are illustrations of examples of omni-directional and directional channel beams that may be used in a wireless network such as illustrated in FIG. 1.

FIG. 5a is an illustration of a sequence of superframes and a breakdown of an example of a superframe time period that may be used in a wireless network such as illustrated in FIG. 1.

FIG. 5b is an illustration of an example of time division duplexing of the low and high rate channels illustrated in FIG. 3 within a superframe period.

FIG. 6 is a block diagram illustrating an example of a device coordinator that may be used in a wireless network such as illustrated in FIG. 1.

FIG. 7 is a block diagram illustrating an example of a device that may be used in a wireless network such as illustrated in FIG. 1.

FIG. 8 is a flowchart illustrating an example of a method of performing medium access control in a wireless network such as illustrated in FIG. 1.

FIG. 9 is a flowchart illustrating an example of another method of performing medium access control in a wireless network such as illustrated in FIG. 1.

FIG. 10 is a diagram illustrating an embodiment of a data packet that may be used in a bandwidth request message as used in the methods illustrated in FIGS. 8 and 9.

FIG. 11 is a diagram illustrating an embodiment of a data packet that may be used in a bandwidth response message as used in the methods illustrated in FIGS. 8 and 9.

FIG. 12 is a diagram illustrating an embodiment of a data packet that may be used in a bandwidth response message as used in the methods illustrated in FIGS. 8 and 9.

FIG. 13a is a diagram illustrating an example of time slot locations of superframe time blocks on a high rate channel, a primary low rate channel and a secondary low rate channel as may be used in the methods illustrated in FIGS. 8 and 9.

FIG. 13b is a diagram illustrating another example of time slot locations of superframe time blocks on a high rate channel, a primary low rate channel and a secondary low rate channel as may be used in the methods illustrated in FIGS. 8 and 9.

FIG. 13c is a diagram illustrating another example of time slot locations of superframe time blocks on a primary low rate channel and on two secondary low rate channels as may be used in the methods illustrated in FIGS. 8 and 9.

FIG. 14 is a flowchart illustrating an example of another method of performing medium access control in a wireless network such as illustrated in FIG. 1.

### DETAILED DESCRIPTION OF CERTAIN INVENTIVE EMBODIMENTS

Certain embodiments provide a method and system for transmission of uncompressed HD video information from a sender to a receiver over wireless channels.

The following detailed description is directed to certain sample embodiments of the invention. However, the invention can be embodied in a multitude of different ways as defined and covered by the claims. In this description, reference is made to the drawings wherein like parts are designated with like numerals throughout.

Embodiments include systems and methods of improving processing in communication devices in a wireless system for communication of uncompressed video data. Video data may include one or more of motion video, still images, or any other suitable type of visual data. Embodiments include apparatus and methods of performing link and/or medium access control of a low rate channel for communication of data between devices in the wireless system. An aspect of these embodiments includes using a bandwidth request message to request a reserved timeslot within a superframe period where the reserved time slot meets the bandwidth requested in the request message. A device coordinator determines the capability of the devices identified in the bandwidth request message to transmit and/or receive on a high rata channel. In one aspect, frequency bands associated with the high rate channel and the low rate channel overlap and the low and high rate channels are utilized in a time division duplexed mode. The device coordinator can reserve timeslots on the low rate channel to meet the bandwidth request if it is determined that the devices identified in the bandwidth request message cannot utilize the high rate channel. In one aspect of these embodiments, a plurality of high rate channels are available, each of which overlaps a plurality of low rate channels. In this aspect, the device coordinator can reserve the time slots meeting the bandwidth requirement on one or more selected low rate channels where sufficient time is available (e.g. the overlapping high rate channel and the selected low rate channel are not being utilized during the reserved time slot).

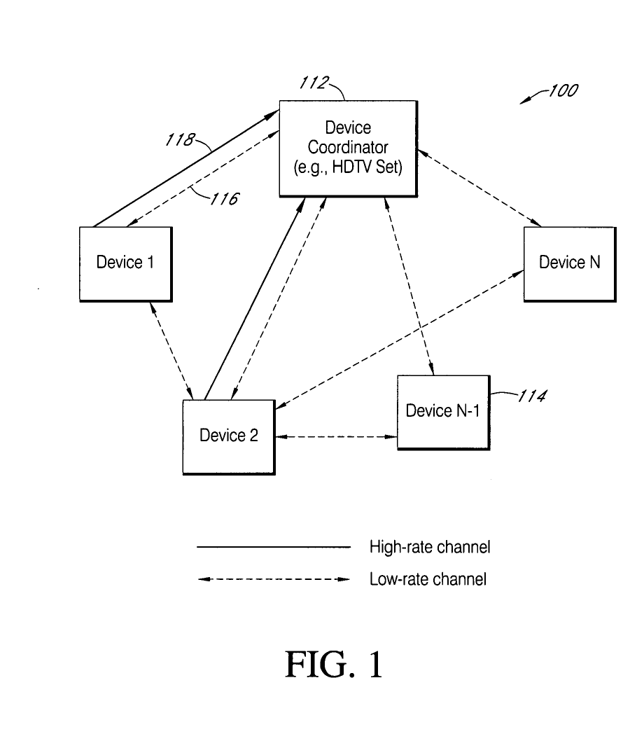

Example implementations of the embodiments in a wireless high definition (HD) audio/video (A/V) system will now be described. FIG. 1 shows a functional block diagram of a wireless network 100 that implements uncompressed HD video transmission between A/V devices such as an A/V device coordinator and A/V stations, according to certain embodiments. In other embodiments, one or more of the devices can be a computer, such as a personal computer (PC). The network 100 includes a device coordinator 112 and multiple A/V stations or devices 114 (e.g., Device 1, . . . , Device N).

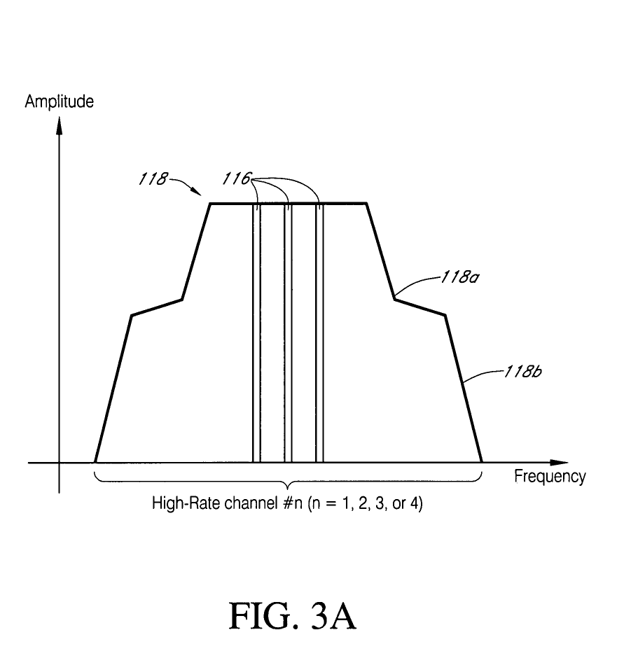

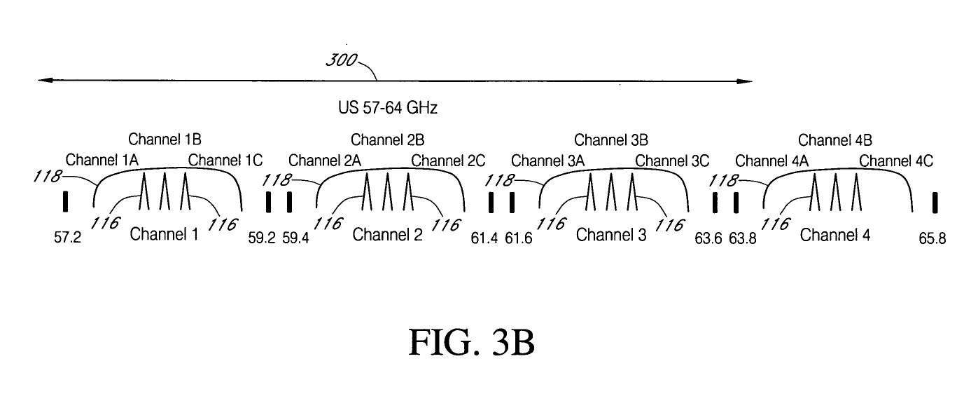

The A/V stations 114 utilize a low rate (LR) wireless channel 116 (dashed lines in FIG. 1), and may use a high rate (HR) channel 118 (heavy solid lines in FIG. 1), for communication between any of the devices. The device coordinator 112 uses a low rate channel 116 and a high rate wireless channel 118, for communication with the stations 114. Each station 114 uses the low rate channel 116 for communications with other stations 114. The high rate channel 118 supports single direction unicast transmission over directional beams established by beamforming, with e.g., multi-Gbps bandwidth, to support uncompressed HD video transmission. For example, a set-top box can transmit uncompressed video to a HD television (HDTV) over the high rate channel 118. The low rate channel 116 can support bi-directional transmission, e.g., with up to 40 Mbps throughput in certain embodiments. The low rate channel 116 is mainly used to transmit control frames such as acknowledgement (ACK) frames. For example, the low rate channel 116 can transmit an acknowledgement from the HDTV to the set-top box. It is also possible that some low rate data like audio and compressed video can be transmitted on the low rate channel between two devices directly. Time division duplexing (TDD) is applied to the high rate and low rate channel. At any one time, the low rate and high rate channels cannot be used in parallel for transmission, in certain embodiments. Beamforming technology can be used in both low rate and high rate channels. The low rate channels can also support omni-directional transmissions. Details of the low and high rate channels will be discussed below in reference to FIGS. 3 and 4.

In one example, the device coordinator 112 is a receiver of video information (referred to as “receiver 112”), and the station 114 is a sender of the video information (referred to as “sender 114”). For example, the receiver 112 can be a sink of video and/or audio data implemented, such as, in an HDTV set in a home wireless network environment which is a type of WLAN. The sender 114 can be a source of uncompressed video or audio. Examples of the sender 114 include a set-top box, a DVD player or recorder, digital camera, camcorder, and so forth.

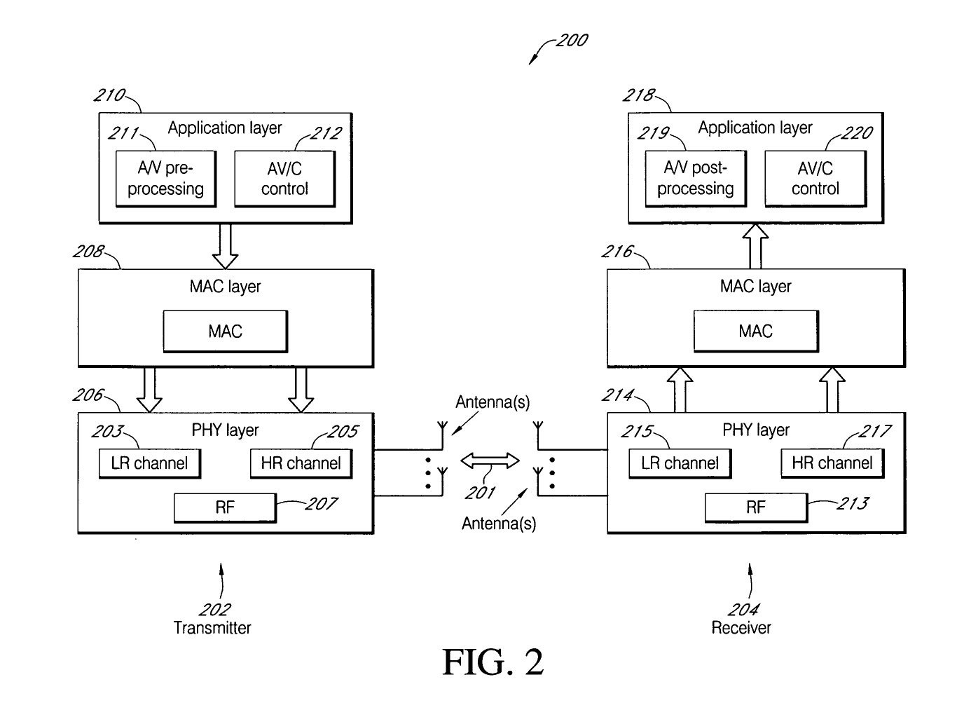

FIG. 2 illustrates a functional block diagram of an example communication system 200. The system 200 includes a wireless transmitter 202 and wireless receiver 204. The transmitter 202 includes a physical (PHY) layer 206, a media access control (MAC) layer 208 and an application layer 210. Similarly, the receiver 204 includes a PHY layer 214, a MAC layer 216, and an application layer 218. The PHY layers provide wireless communication between the transmitter 202 and the receiver 204 via one or more antennas through a wireless medium 201

The application layer 210 of the transmitter 202 includes an A/V pre-processing module 211 and an audio video control (AV/C) module 212. The A/V pre-processing module 211 can perform pre-processing of the audio/video such as partitioning of uncompressed video. The AV/C module 212 provides a standard way to exchange A/V capability information. Before a connection begins, the AV/C module negotiates the A/V formats to be used, and when the need for the connection is completed, AV/C commands are used to stop the connection.

In the transmitter 202, the PHY layer 206 includes a low rate (LR) channel 203 and a high rate (HR) channel 205 that are used to communicate with the MAC layer 208 and with a radio frequency (RF) module 207. In certain embodiments, the MAC layer 208 can include a packetization module (not shown). The PHY/MAC layers of the transmitter 202 add PHY and MAC headers to packets and transmit the packets to the receiver 204 over the wireless channel 201.

In the wireless receiver 204, the PHY/MAC layers 214, 216, process the received packets. The PHY layer 214 includes a RF module 213 connected to the one or more antennas. A LR channel 215 and a HR channel 217 are used to communicate with the MAC layer 216 and with the RF module 213. The application layer 218 of the receiver 204 includes an A/V post-processing module 219 and an AV/C module 220. The module 219 can perform an inverse processing method of the module 211 to regenerate the uncompressed video, for example. The AV/C module 220 operates in a complementary way with the AV/C module 212 of the transmitter 202.

As discussed above, the frequency bands of the low rate and high rate channels overlap. There may be portions of the high rate channel that may not overlap with a low rate channel and conversely, there may be portions of a low rate channel that do not overlap the high rate channel, depending on the embodiment. FIG. 3a is a frequency map of an example of overlapping high rate and low rate channels that may be used in a wireless network such as illustrated in FIG. 1. In this example, three low rate channels 116 are positioned within a single high rate channel 118. There can be more or fewer low rate channels 116 than three as in this example. The low rate channels 116 may have a bandwidth in a range from about 50 MHz to about 200 Mhz, preferably from about 80 MHz to about 100 Mhz.

There may also be multiple high rate channels 118 as indicated by the “channel #n” in FIG. 3a. FIG. 3b is a frequency map of an example of multiple high rate channels each overlapping with 3 low rate channels that may be used in a wireless network such as illustrated in FIG. 1. In this example, there are 4 high rate channels 118. The high rate and low rate channels may be present in any frequency band. The bandwidth of the high rate channel used depends on the data rate of the uncompressed video to be communicated. The bandwidth may be large enough to support a data rate in a range from about 1 Gbps to about 4 Gbps. Frequency bands that are used for other wireless systems can be used. The choice of frequency bands may depend on the regulatory agency of the country in which the system is being used. For unlicensed devices, there are allocated frequency spectrum. In the United States for example, frequency bands allocated for unlicensed devise include those referred to as 800 MHz, 2.4 GHz, 5 GHz and 60 GHz. In one embodiment, the 60 GHz band is used.

In the example shown in FIG. 3b, the 60 GHz frequency band is used. Table 1 lists the start, stop and center frequencies of the four high rate channels 118. Due to regulatory restrictions, all four high rate channels 118 may not be available in all geographic regions. For example, the 60 GHz frequency band allocated in the United States comprises frequencies from about 57 GHz to about 64 GHz as shown by the Ref. No. 300 in FIG. 3b. Therefore, the number of high rate channels 118 available in the United States may be limited to the high rate channels 118 labeled Channel 1, Channel 2 and Channel 3 in the FIG. 3b since the high rate channel 118 labeled Channel 4 lies outside of the U.S. 60 GHz frequency band.

TABLE 1

| High Rate | | | |
|---|---|---|---|
| Channel | | | |
| Index | Start frequency | Center frequency | Stop frequency |
| (HRI) | (GHz) | (GHz) | (GHz) |
| 1 | 57.2 | 58.2 | 59.2 |
| 2 | 59.4 | 60.4 | 61.4 |
| 3 | 61.6 | 62.6 | 63.6 |
| 4 | 63.8 | 64.8 | 65.8 |

The low rate channels 116 overlap with the high rate channels 118 in the embodiment shown in FIG. 3b. In the example shown in FIG. 3b, three low rate channels 116 are located in each high rate channel 118. In this example, the low rate channels 116 each have a width of 80 MHz. Each low rate channel 116 is defined relative to the center frequency “fc(HRI)” of the high rate channel 118 (e.g. the center frequencies listed in Table 1) which it overlaps with. Table 2 lists the low rate channels 116 frequency bands as a function of the high rate channel center frequency. It should be noted that the number of low rate channels 116 in a high rate channel 118 may be different than three as shown in FIG. 3b. Also, the bandwidth of the low rate channels may be different than the 80 MHz bandwidth in this example.

TABLE 2

| Low rate | | | |
|---|---|---|---|
| Channel | Start frequency | Center frequency | Stop frequency |
| index | (GHz) | (GHz) | (GHz) |
| 1 | fc(HRI) − 240 MHz | fc(HRI) − 200 MHz | fc(HRI) − |
| | | | 160 MHz |
| 2 | fc(HRI) − 40 MHz | fc(HRI) | fc(HRI) + |
| | | | 40 MHz |
| 3 | fc(HRI) + 160 MHz | fc(HRI) + 200 MHz | fc(HRI) + |
| | | | 240 MHz |

The frequency bands listed in Tables 1 and 2 are one example of a low and high rate channel frequency plan. In general, there could be m*n low rate channels (F1, . . . , Fm*n) within m high rate channels such that n low rate channels (F1, . . . , Fn) are within one high rate channel. Typically, the coordinator shall select one out of n low rate channels for transmitting beacons, control frames, Ack, etc. This low rate channel is referred as Primary-LRP channel from herein.

FIGS. 4a and 4b are illustrations of examples of omni-directional and directional channel beams that may be used in a wireless network such as illustrated in FIG. 1. FIG. 4a depicts a device coordinator 112 communicating with a device 114 over a low rate channel 116. The low rate channel 116 can be used in either an omni-directional mode, as illustrated by the circular coverage areas 116a, or a directional mode, e.g., using beam steering, as illustrated by the narrow beam coverage areas 116b. In either case, the low rate channel 116 is a symmetric channel where devices transmit and receive information. FIG. 4b depicts a device coordinator 112 and a device 114 communicating uncompressed video over a high rate channel 118. The high rate channel 118 is an asymmetric directional channel as depicted by the narrow beam coverage areas of FIG. 4b. In one embodiment, a directional low rate channel is used in conjunction with the asymmetric directional high rate channel for communication of Acks, etc., from the device coordinator 112 to the device 114.

In one embodiment, the low rate channel uses OFDM (orthogonal frequency division multiplexing) in both the omni-directional and directional modes. However, other suitable transmission protocols may be used, including, for example, code division multiple access (CDMA) frequency division multiple access (FDMA) system, time division multiple access (TDMA), frequency hopping, etc. The low rate channel omni-directional mode is used for transmission of control data such as beacon messages (discussed below), network/device association and disassociation, device discovery, acknowledgements, device capability and preference exchanges, etc. The low rate channel directional or beamformed mode can be used for communicating audio signals and/or compressed video signals. The low rate channel directional mode is not as reliable due to frequently changing channel conditions including blockages by objects such as people, furniture, walls, etc. For this reason, the omni-directional mode is used for the majority of control signals since it is more reliable and movement of the receiver and/or transmitter has less effect on the ability to maintain a connection. The low rate channel omni-directional mode offers data rates in a range from about 2.5 Mbps to about 10 Mbps. The low rate channel directional mode offers data rates in a range from about 20 Mbps to about 40 Mbps. However, other data rates are envisioned as being possible.

The directional modes of the low rate and high rate channels can be used for multiple simultaneous connections between devices since the transmission beams are narrow and may not adversely affect one another. However, the low rate channel omni-directional transmissions (as depicted by the circular coverage areas 116a in FIG. 4a) can interfere with any device coordinator 112 or device 114 within range. For this reason, the low rate channel omni-directional transmissions are time division duplexed with the directional transmissions (both low rate and high rate) with overlapping frequencies. Time division duplexing of low rate channel omni-directional transmissions and the high rate channel directional transmissions will now be discussed.

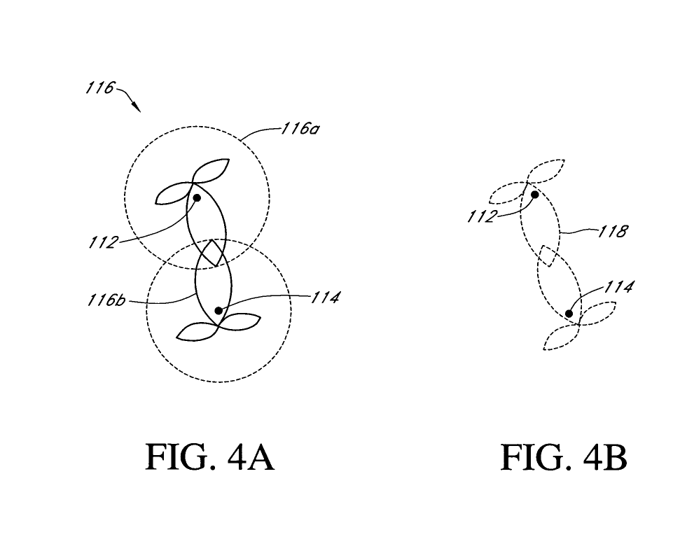

Many time division duplexing (TDD) channel access control schemes may be used to coordinate transmissions of the low rate and high rate channels within a network. The goal of the TDD scheme is to only have one of the two channels, low rate or high rate, being used for transmission at any one time. An example of a channel access control scheme used to coordinate the low rate and high rate channels is a superframe-based scheme. FIG. 5a is an illustration of a sequence of superframes and a breakdown of an example of a superframe time period that may be used in a wireless network such as illustrated in FIG. 1. In a superframe base transmission system, the transmission time is broken into a series of superframes 500. The length of time of the superframe is made small enough to allow for frequent medium access control (this cuts down on delays in processing control signals that enable access), but is made long enough to provide for efficient throughput of uncompressed video data. Large delays in processing user commands, such as on/off, channel switch, volume change, etc., will negatively affect the user experience. For these reasons, a superframe time is typically in a range from about 16 msec. to about 100 msec.

In the example superframe scheme shown in FIG. 5a, each superframe is divided into three main time frames, a beacon frame 505, a control period frame 510 and a frame for reserved and unreserved channel time blocks (CTB's) 515. The time frame for reserved and unreserved CTB's is herein referred to as the CTB frame 515. The beacon frame 505 is used to set the timing allocations for the reserved and unreserved CTBs of the CTB frame 515. A device coordinator 112, such as a TV set, for example, communicates reserved time slots to the multiple devices 114 in a network such as the network 100 in FIG. 1.

The control period frame 510 is used to allow devices to transmit control messages to a device coordinator. Control messages may include network/device association and disassociation, device discovery, time slot reservations, device capability and preference exchanges, etc. The control period frame 510 may use a contention based access system such as Aloha, slotted Aloha, CSMA (carrier sensed multiple access), etc., to allow multiple devices to send control messages and to handle collisions of messages from multiple devices. When a message from a device is received at a device coordinator without suffering a collision, the device coordinator can respond to the request of the message in the beacon frame 505 of a subsequent superframe 500. The response may be a time slot reservation of a CTB in one or more subsequent superframes 500.

The CTB frame 515 is used for all other transmissions other than beacon messages and contention based control messages which are transmitted in the beacon frame 505 and the control frame 510. Reserved CTBs are used to transmit commands, isochronous streams and asynchronous data connections. CTB's can be reserved for transmission by a device coordinator to a specific device, for transmission by a device to a device coordinator, for transmission by a device to another device, etc. A CTB can be used to transmit a single data packet or multiple data packets. A CTB frame can include any number of reserved or unreserved CTB's. Unreserved CTB's in the CTB frame 510 can be used for communication of further contention based commands on the low rate channel such as remote control commands (e.g., CEC commands), MAC control, and management commands.

It is desirable to make the length of the control frame 510 as small as possible while still allowing many devices to be able to successfully access the network without undue time delay, e.g., due to message collision. In one embodiment, the only messages that are sent on a contention basis are control initiation request messages that identify a requesting device and a type of message sequence exchange to be scheduled in a reserved CTB. In this way, the sizes of the messages that are contention based are kept to a minimum. All other message exchanges on the low rate channel can be scheduled.

In order for a message of a device to be identified by a receiving device coordinator, a preamble is used at the start of a contention based message. The preamble is a predetermined bit sequence that can be identified by the device coordinator (or any receiving device). In one embodiment, carrier sensing is particularly difficult in the 60 GHz frequency range and the length of the preamble may be in a range from about 50 microseconds to about 75 microseconds. Such long preambles make it very difficult to keep the control frame 510 to a desired short time duration. It can be envisioned that with many devices, there could be a large number of collisions occurring in the control period 510, especially if the data being communicated is large, such as in a device capability message. Therefore, an efficient method of processing control messages is needed. In embodiments where the preamble is in a range from about 50 microseconds to about 75 microseconds, the length of the control frame 510 may be in a range from about 100 microseconds to about 600 microseconds.

FIG. 5b is an illustration of an example of time division duplexing of the low and high rate channels illustrated in FIG. 3 within a superframe period. FIG. 5b shows which channels can be used for transmission in the various superframe sub-frames shown in FIG. 5a. In one embodiment, the low rate channel 116 only is used for transmission during the beacon frame 505, and the control frame 510. Both the high rate and low rate channels can be used for transmission during the CTB frame 515. Any of the beacon frame 505, the control frame 510 and the CTB frame 515 can have either fixed or variable durations, depending on the embodiment. Likewise, the superframe 500 time duration can be fixed or variable, depending on the embodiment.

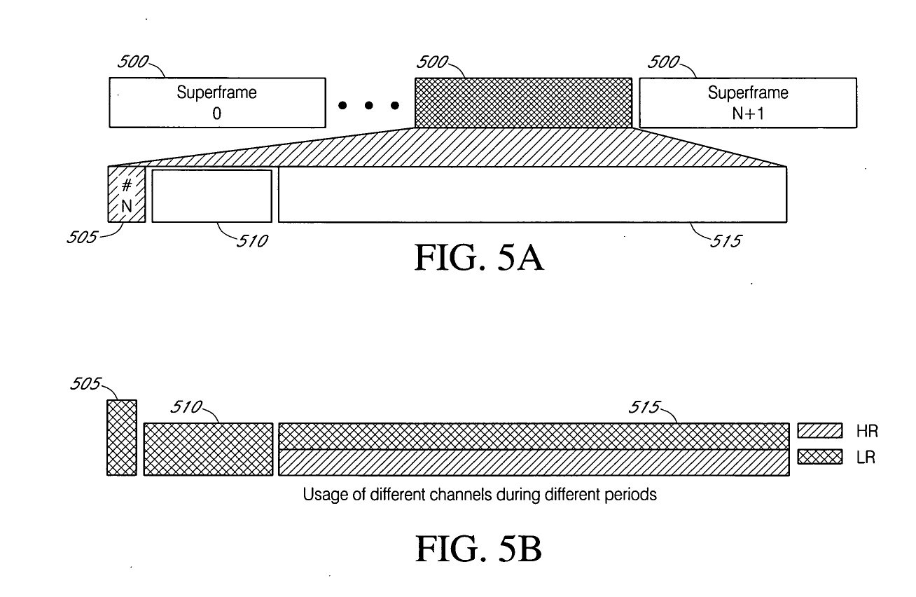

FIG. 6 is a block diagram illustrating an example of a device coordinator that may be used in a wireless network such as illustrated in FIG. 1. In this embodiment, the device coordinator 600 comprises processor element 605, a memory element 610, a receiver element 615, a transmitter element 620, and a link control element 625. The processor 605 may include one or more of a general purpose processor and/or a digital signal processor and/or an application specific hardware processor. The memory 610 may include one or more of integrated circuits or disk based storage or any readable and writeable random access memory device. The processor 605 is coupled to the memory 610 and the other elements to perform the various actions of the other elements. The receiver 615 receives data transmitted by other devices in the network 100, such as the devices 114. The receiver can be configured to receive data over the low rate channel 116 and/or the high rate channel 118. The transmitter 620 transmits data over the network 100. The transmitter 620 can be configured to transmit over the low rate channel only as depicted in the device coordinator 112 in the network 100 of FIG. 1, or to transmit over the high rate channel 118 as well, for example to a digital video recorder device (not shown).

The link control element 625 determines time slots to reserve for devices that have requested a specified bandwidth on the low rate and/or high rate channels. The requests may specify the type of channel that is needed (e.g., the low rate or the high rate channel). In one embodiment, the link control element 625 is configured to determine if the high rate channel can be used by the requesting device or devices. If it is determined that the high rate channel can be used by the requesting device or devices, one of the high rate channels may be chosen. If it is determined that the high rate channel cannot be utilized (e.g., due to one of the requesting devices not having the capability to transmit on the high rate channels), the link control element 625 can determine a time slot available on one of the plurality of low rate channels. The time slot reservation request may indicate a type of multimedia bitstream that is to be transmitted, such as an uncompressed 1080i or 1080p HDTV video bitstream, or an audio bitstream, etc. The link control element 625 is configured to determine the duration of the reserved time slot that will satisfy the bandwidth requirements of the bandwidth request and to identify where in the superframe period to locate the reserved time slot. Information representing the time slot location within the superframe, the index of the selected channel and identities of the affected devices is then encoded into a message to be transmitted to the one or more devices and/or other device coordinators affected by the time slot reservation request.

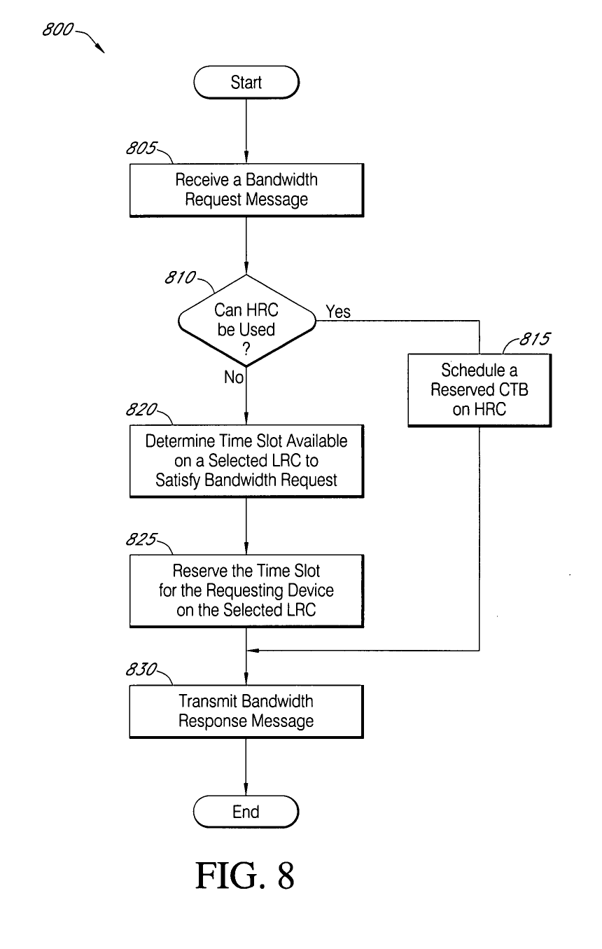

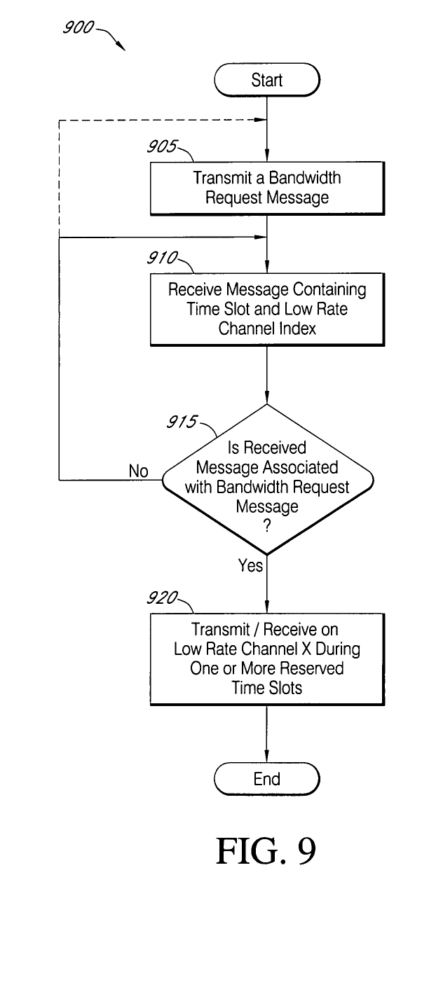

In some embodiments, one or more of the elements of the device coordinator 600 of FIG. 6 may be rearranged and/or combined. The elements may be implemented by hardware, software, firmware, middleware, microcode or any combination thereof. Details of the actions performed by the elements of the device coordinator 600 will be discussed in reference to the methods illustrated in FIGS. 8 and 9 below.

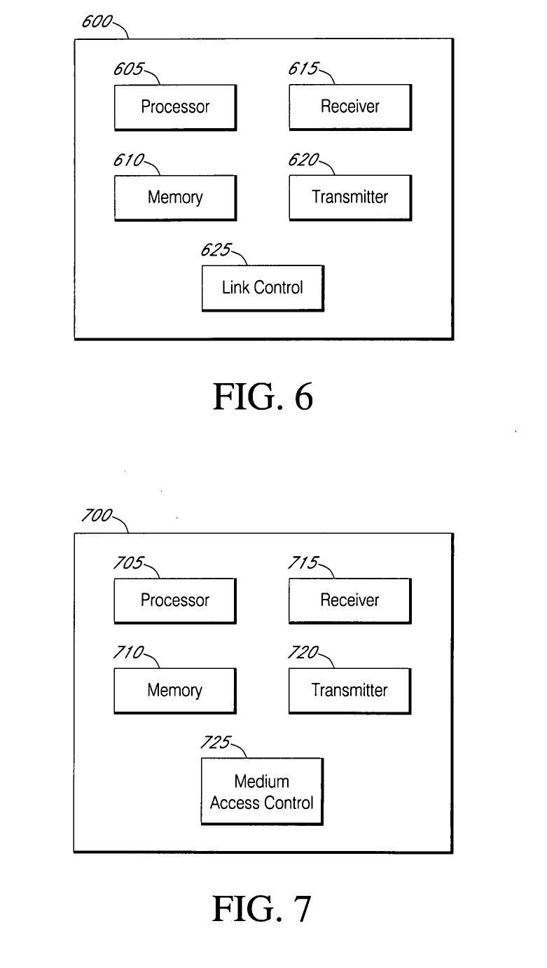

FIG. 7 is a block diagram illustrating an example of a device that may be used in a wireless network such as illustrated in FIG. 1. In this embodiment, the device 700 comprises processor element 705, a memory element 710, a receiver element 715, a transmitter element 720, and a medium access control element 725. The processor 705 may include one or more of a general purpose processor and/or a digital signal processor and/or an application specific hardware processor. The memory 710 may include one or more of integrated circuits or disk based storage or any readable and writeable random access memory device. The processor 705 is coupled to the memory 710 and the other elements to perform the various actions of the other elements. The receiver 715 receives data transmitted by other devices in the network 100, such as the device coordinator 112 or other devices 114. The receiver can be configured to receive data over the low rate channel 116 and/or the high rate channel 118. The transmitter 720 transmits data over the network 100. The transmitter 720 can be configured to transmit over the low rate channel only as depicted in the device labeled Device N in the network 100 of FIG. 1, or to transmit over both the low rate channel 116 and the high rate channel 118 as in the device labeled Device 2.

The medium access control element 725 generates bandwidth request messages (e.g., requesting a new connection or modification of an established connection) to be transmitted to the device coordinator 112 of the network 100. The bandwidth request messages may be requests for initiation/termination of an asynchronous connection between a device and a device coordinator or for a direct connection between two devices. The medium access control element 725 determines the content of the bandwidth request message and formats the message with various data fields. The fields may include information indicating the required bandwidth and duration that the requested bandwidth is desired for. The fields may include a source ID field and a destination ID field. The medium access control element 725 is also configured to interpret reserved time slot information and channel identification information received from the device coordinator 112. The time slot information indicates reserved time blocks to receive and/or transmit messages and/or multimedia content in future superframes. The channel identification information indicates which of the low rate channels and/or high rate channels the reserved time slots apply to. The medium access control element 725 may also determine the destination device or source device to transmit to or receive from, respectively.

In some embodiments, one or more of the elements of the device 700 of FIG. 7 may be rearranged and/or combined. The elements may be implemented by hardware, software, firmware, middleware, microcode or any combination thereof. Details of the actions performed by the elements of the device 700 will be discussed in reference to the methods illustrated in FIGS. 8 and 9 below.

FIG. 8 is a flowchart illustrating an example of a method of performing medium access control in a wireless network such as illustrated in FIG. 1. Method 800 includes link control functions that are performed by a device coordinator such as the device coordinator 112 in FIG. 1. Since the cost of supporting transmission and/or reception of the high rate channel may be significant in comparison to supporting only transmission or reception on the low rate channel, it may be reasonable to expect a number of devices 114 that are only capable of communication on the low rate channel. The method 800 enables the device coordinator 112 to schedule traffic to and/or from the multiple devices 114 on one or more of the plurality of low rate channels 116 in an efficient manner. In one embodiment, the low rate channels overlap with a high rate channels. In this embodiment, when one or more of the low rate channels are being utilized, the high rate channel may not be utilized. The method 800 enables a device coordinator to determine which low rate channels to use and when to use them such that the throughput on the one or more high rate channels may be improved.

The method 800 starts at block 805 where a bandwidth request message is received by the device coordinator 112. The bandwidth request message is typically received over a low rate channel, such as the primary low rate channel as discussed above, where all devices may communicate on the low rate channel. The bandwidth request message can be received during the control frame 510, or during a reserved or unreserved time block of the CTB frame 515 of the superframe 500 as shown in FIG. 5a. In one embodiment, the bandwidth requests are transmitted over a low rate channel that is designated as the primary low rate channel. The primary low rate channel is used for transmission of beacon messages and control messages during the beacon frame 505 and the control frame 510 of the superframe 500. The bandwidth request message contains information identifying the device that is requesting a connection on the low rate and/or high rate channels. The connection may be an asynchronous or synchronous connection. The control initiation request message may also contain information identifying a second device (such as the device coordinator 112 or another device 114) that the requesting device is requesting to have a direct connection with. The receiver element 615 of the device coordinator 600 shown in FIG. 6 can perform the functions of the block 805.

In some embodiments, the bandwidth request message contains information identifying the type of connection that is being requested. The type of connection may be one of a plurality of connections including an audio connection, a compressed video connection, a file transfer, etc. The bandwidth request message may also contain information identifying a data rate, a length of time for transmission and/or reception of data, a minimum or maximum time, a minimum or maximum data rate, as well as other types of information known to skilled technologists that could enable a device coordinator to accurately predict the time slot duration and/or the number of superframe periods needed to support the requested message exchange.

After the device coordinator has received the bandwidth request message at block 805, the process 800 continues at decision block 810 where a determination is made if the requested bandwidth can be provided using one of the high rate channels. The device coordinator 112 may obtain capability information of the devices in the network 100 at the time a device is admitted to the network. By knowing the capabilities of the devices identified in the bandwidth request message, the device coordinator can determine if the high rate channel can be utilized. For example if the bandwidth request message is requesting an asymmetric (e.g., a one-way transmission) from device A to device B, then the device A needs the capability of transmitting on the high rate channel and the device B needs the capability to receive the high rate channel. If these capabilities are present in devices A and B, then the high rate channel may be utilized. If the bandwidth request message is requesting a symmetric connection between device A and device B, then both device A and device B need to be capable of transmitting and receiving on the high rate channel in order to utilize the high rate channel for the requested connection. Also, it is possible that device A can only receive on the high rate channel and device B can only transmit on HRC. In this case, device A cannot transmit to device B on the high rate channel. The link control element 625 of the device coordinator 600 shown in FIG. 6 can perform the functions of the decision block 810.

If it is determined at block 810 that the high rate channel can be used for the requested connection, then the process 800 continues at block 815 where one or more CTB's within the CTB frame 515 of the superframe 500 are reserved to meet the bandwidth request. However, if it is determined for one or more reasons that the high rate channel may not be utilized for providing the requested bandwidth for the requested connection, the process 800 continues at block 820. At block 820, the device coordinator determines if one or more time slots satisfying the bandwidth request are available on one of the low rate channels. The determination at block 820 includes determining which time slots are available in upcoming superframes for each of the high rate channels 118 and the corresponding low rate channels 116 contained within each of the high rate channel 118, in the embodiment shown in FIG. 3B. For example, if an uncompressed 1080p video bitstream is being supported on the first high rate channel 116 shown in FIG. 3b, then there may be a very small portion of time in the CTB frame 515 of the superframe 500 that is not reserved. For example, there may be 5% or less of the total CTB frame available in the superframe for bandwidth reservation. In this case, if a 20 Mbps audio connection is being requested, and the low rate channels 118 within the first channel can support 40 Mbps at maximum capacity, then 5% of the 40 Mbps would only support a 2 Mbps connection. In this case, the device coordinator 112 may determine that one of the low rate channels 116 within the second high rate channel 118 is available (assuming that the second high rate channel and the selected low rate channel are not being utilized during the determined time slots). Thus, the connection can be supported on a secondary low rate channel 116 that is outside of the nearly fully utilized high rate channel (HRC).

If a high rate channel 118 is being utilized in a given time slot, then this time slot is not available for any of the low rate channels 116 that the high rate channel 118 overlaps with. However, if the high rate channel 118 is not being utilized in a give time slot, then this time slot can be used by each of the low rate channels 118 with which the high rate channel overlaps. In the exemplary system represented in FIG. 3, there could be three low rate channels being utilized in time slots where the overlapping high rate channel is not being utilized. The selected low rate channel can be the primary low rate channel or a secondary low rate channel within the same high rate channel as the primary low rate channel, or a secondary low rate channel within another high rate channel. The link control element 625 of the device coordinator 600 shown in FIG. 6 can perform the functions of the block 820.

After an available time slot and low rate channel 116 are determined at block 820, the process 800 continues at block 825 where the selected time slots and low rate channel 116 are reserved by the device coordinator for use by the requesting device or devices. The link control element 625 of the device coordinator 600 is configured to keep track of the reserved time slots for all of the low rate channels 116 and the high rate channels 118 supported by the network 100.

Subsequent to determining the reserved time-slot duration and location in future superframes, and the reserved low rate and/or high rate channel index, the process 800 continues at block 830 where a bandwidth response message is transmitted to the requesting device or devices. The bandwidth response message is encoded with the time slot information determined at block 815 or block 820. The time slot information may include one or more reserved CTB time slots within the superframe CTB frame 515 (see FIG. 5). The reserved CTB time slots may include an uplink CTB for the requesting device to transmit messages to the device coordinator 112 or to another device 114. The reserved CTB time slots may include a downlink for the device coordinator 112 or another device 114 to transmit messages to the requesting device 114. The reserved CTB time slot may include a combined uplink/downlink time slot for synchronous communication between the requesting device and the device coordinator 112 or another device 114. Multiple reserved CTB time slots may be reserved for a single device 114 within a single CTB frame 515 of a superframe 500. The time slot information may also include a start time and/or a termination time (e.g., a number of superframes for which the reserved CTB time slot is available). The bandwidth response message also contains device address information that identifies the device or devices for which the uplink and/or downlink time-slots apply.

In some embodiments, as discussed above, a secondary low rate channel can be reserved for communication between a device 114 and a device coordinator 112. In these embodiments, the device coordinator 112 can simultaneously communicate on two low rate channels if the coordinator has two sets of transceivers, both which consist of a transmitter and a receiver. The device coordinator 112 may function as the coordinator on the primary low rate channel and function as a normal device on the secondary low rate channel. In this way, the device coordinator can function as two virtual devices within one physical device.

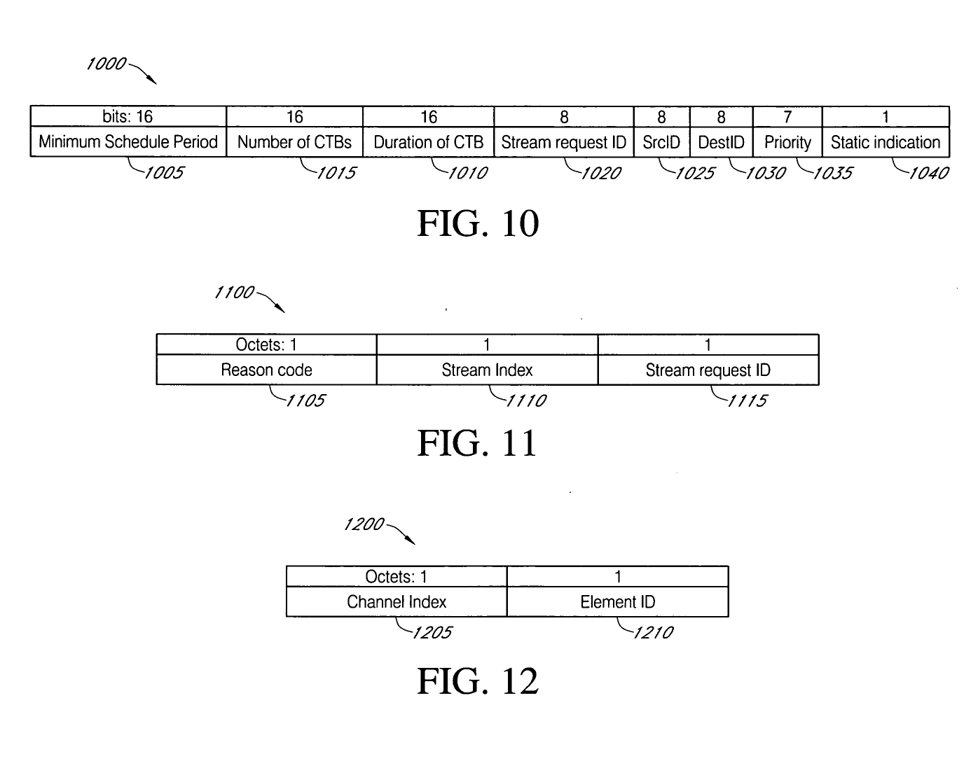

In some embodiments, the bandwidth response message transmitted at block 820 is transmitted during a beacon frame period 505 of a superframe 500, as shown in FIG. 5. The response message may be one of a plurality of response messages containing time-slot information targeted for multiple devices. The plurality of response messages may be combined/aggregated into a single beacon frame 505. Details of data fields contained in one embodiment of a bandwidth response message are discussed below in reference to FIGS. 10-12. The transmitter element 620 of the device coordinator 600 shown in FIG. 6 can perform the functions of block 830.

Thus the process 800 provides an efficient method for a device coordinator 112 to receive bandwidth request messages, at block 805, from a plurality of devices 114. The device coordinator can then determine, at block 810, if the requested bandwidth connection can be supported on the high rate channel. The device coordinator can then select from a plurality of low rate channels, including a primary low rate channel and secondary low rate channels, to support the requested connection. In this way, devices that do not support transmission and/or reception of data on the high rate channel can be admitted to the network to utilize the low rate channels in an efficient manner.

FIG. 9 is a flowchart illustrating an example of another method of performing medium access control in a wireless network such as illustrated in FIG. 1. Method 900 includes medium access control functions that are performed by a device such as the devices 114 in FIG. 1. Since the cost of supporting transmission and or reception of the high rate channel may be significant in comparison to supporting only transmission or reception on the low rate channel, it may be reasonable to expect a number of devices 114 that are only capable of communication on the low rate channel. The method 900 enables the device 114 to request a bandwidth on one of the low rate channels for communication with a device coordinator 112 or another device 114. In one embodiment, the low rate channels overlap with a high rate channel. In this embodiment, when one or more of the low rate channels are being utilized, the high rate channel may not be utilized (e.g., for transmission of uncompressed digital video).

The method 900 starts at block 905 where a bandwidth request message is transmitted by the device 114. Note, in a network where multiple coordinators may be present (e.g., a second coordinator may control a sub-network of a main network), a device coordinator may perform the process 900 as a device to the other device coordinator. The bandwidth request message is typically transmitted over the primary low rate channel. The bandwidth request message can be transmitted during the control frame 510 of the superframe 500 as shown in FIG. 5a. The bandwidth request message may also be transmitted in an unreserved CTB period of the CTB frame 515 in the superframe 500. The bandwidth request message contains information identifying the device 114 that is requesting the connection of a specified bandwidth (e.g. or a specified data rate that the device coordinator can translate into an equivalent bandwidth). The bandwidth request message may also contain information identifying a second device (such as the device coordinator 112 or another device 114) that the requesting device is requesting to communicate with using the requested bandwidth. Details of data fields contained in an exemplary bandwidth request message are discussed below in reference to FIG. 10. The transmitter element 720 of the device 700 shown in FIG. 7 can perform the functions of the block 905.

Subsequent to transmitting the bandwidth request message at block 905, the process 900 continues at block 910 where a response message is received by the requesting device. The response message may be transmitted by a device coordinator 112 using the method 800 shown in FIG. 8 and discussed above. The response message is encoded with the time slot information and the selected channel index (high rate or low rate channel) such as determined by the device coordinator 112 at block 815 or block 820 of the process 800. The time slot information may include one or more reserved CTB time slots within the superframe CTB frame 515 (see FIG. 5). The reserved CTB time slots may include an uplink CTB for the requesting device to transmit messages to the device coordinator 112 or to another device 114. The reserved CTB time slots may include a downlink for the requesting device to receive messages from the device coordinator 112 or another device 114. The reserved CTB time slot may include a combined uplink/downlink time slot for direct communication between the requesting device and the device coordinator 112 or another device 114. Multiple reserved CTB time slots may be reserved for a single device 114 within a single CTB frame 515 of a superframe 500. The time slot information may also include a start time and/or a termination time (e.g., a number of superframes for which the reserved CTB time slot is available). The response message also contains device address information that identifies the device or devices for which the uplink and/or downlink time-slots apply.

In some embodiments, the response message received at block 910 is received during the beacon frame period 505 of the superframe 500, as shown in FIG. 5. The response message may be one of a plurality of response messages containing time-slot information targeted for multiple devices 114. The plurality of response messages may be combined or aggregated into a single beacon frame 505. The receiver element 715 of the device 700 shown in FIG. 7 can perform the functions of block 910.

Since response messages may be targeted to multiple devices 114, the process 900 continues at decision block 915 where the device 114 determines if the response message received at block 910 is associated with the bandwidth request message transmitted by the device 114 at block 905. As discussed above, the response message received at block 910 contains device address information identifying the device or devices which the response message is targeted for. If the device address information contained in the response message matches the device address of the device 114 performing the process 900, then it can be determined that the message is in response to the control initiation request message previously transmitted at block 905.

If it is determined, at block 915, that the response message is not associated with the transmitted control initiation request message, the process 900 returns to block 910 where the device waits to receive another response message. Optionally, the process 900 may return to block 905 (as indicated by the dashed arrow) where another bandwidth message is transmitted. The return to block 905 may be triggered based on a default elapsed time, or alternatively the bandwidth response message received at the block 910 may include a reason code stating that the bandwidth is not granted (in this case the device can send another bandwidth request message at the block 905 with a reduced bandwidth request such as initially requested for 1080p and then reduced to 1080i). In this way, if the device coordinator never received the message, e.g., due to a collision of messages during the control frame 505, the device retransmits the request until the device coordinator receives it. If it is determined, at block 915, that the response message is associated with the control initiation request message transmitted at block 905, the process 900 continues to block 920. The medium access control element 725 of the device 700 shown in FIG. 7 can perform the functions of the decision block 915.

At the block 920, the device 114 transmits and/or receives messages during the reserved time slots on the low rate channel or high rate channel identified in the response message that was determined to be associated with the transmitted control initiation request message. The transmitter element 720 and the receiver element 715 of the device 700 shown in FIG. 7 can perform the transmit and receive functions, respectively, of the block 920.

Thus the process 900 provides an efficient method for a device 114 to transmit bandwidth request messages requesting reserved time meeting a specified bandwidth on one or more low rate channels or high rate channels to conduct communication with the device coordinator 112 or other devices 114.

FIG. 10 is a diagram illustrating an embodiment of a data packet 1000 that may be used in a bandwidth request message. The data packet 1000 may be transmitted by the device 114 at block 905 of the process 900 and received by the device coordinator 112 at the block 805 of the process 800 as discussed above. In addition to being used to request a new connection of a certain bandwidth, the bandwidth request message may also be used to modify, or terminate currently reserved channel time slot allocations. For example, a device coordinator 112 may transmit the data packet 1000 to modify an existing connection with a device or devices. The data packet 1000 may be transmitted with other data packets 1000 in the same message (e.g., a MAC command message) in order to modify, request or terminate multiple connections associated with the same requesting device. The field types and sizes of the data packet 1000 are designed for use in the superframe format as discussed above. However, skilled technologists will be able to use other fields to perform similar functions.

The data packet 1000 contains 8 fields comprising a total of 10 octets in this embodiment. A minimum schedule period field 1005 comprises 2 octets (16 bits). The minimum schedule period field 1005 indicates the minimum desired time between the start time of two sequential time blocks for the connection being requested. In a system using the superframe embodiment shown in FIG. 5a with a 20 msec. superframe, the value represented by the minimum schedule period field 1005 may be from 0 microseconds to 20 msec in 1 microsecond increments. A time block duration field 1010 comprises 2 octets in this embodiment. The time block duration field indicates the duration of each time block within the schedule. The resolution of the time block duration field 1010 is 1 microsecond and the valid range is 0 microseconds to 20 msec. A number of CTBs field 1015 contains 2 octets. The number of CTBs field 1015 field indicates the number of time blocks requested per superframe. The use of the three fields 1005, 1010 and 1015 gives a requesting device the ability to request a large variety of connection types. The requested connection types include, but are not limited to, synchronous connections, asynchronous connections, isochronous connections, etc. Skilled technologists will readily recognize other field types that could be employed for identifying bandwidth of a specified amount.

The Stream Request ID field 1020 is used to uniquely identify the Station's request before it receives a stream index from the coordinator device. If the bandwidth request is for a new isochronous stream, then the stream request ID field 1020 is set to a non-zero identifier generated by the originating device that is unique among the device's channel bandwidth requests. The stream request ID field 1020 can remain constant during the entire packet exchange sequence for establishing a new stream. If the bandwidth request is to modify or terminate an existing stream, or the request is for an asynchronous allocation, the stream request ID can be set to zero and can be ignored on reception.

A SrcID (source ID) field 1025, and a DestID (Destination ID) field 1030 each contain 1 octet in this embodiment. The SrcID field 1025 identifies the requesting device. The DestID field 1030 identifies the destination device that the requesting device is requesting a connection with.

A priority field 1035 contains 7 bits in this embodiment. The Priority field 1035 is used to indicate the priority of the stream. It may be determined by a quality of service level to be applied to the stream or for indicating that the stream is being used for a special purpose. If this field is set to 0, no priority is applied.

A static indication field 1040 indicates if a schedule is static or dynamic. A static schedule has the same allocation in successive superframes, i.e., the device coordinator will not change it from superframe to superframe. On the other hand, a dynamic schedule may be different from superframe to superframe.

If a device is assigned a static schedule then the device can continuously use the schedule for up to mMaxLostBeacons missed beacons. Hence, the device using the schedule to transmit isochronous stream in order to prevent bandwidth loss. If a beacon carrying a dynamic schedule is lost, the device will be unable to use the allocated schedule, which will cause throughput loss.

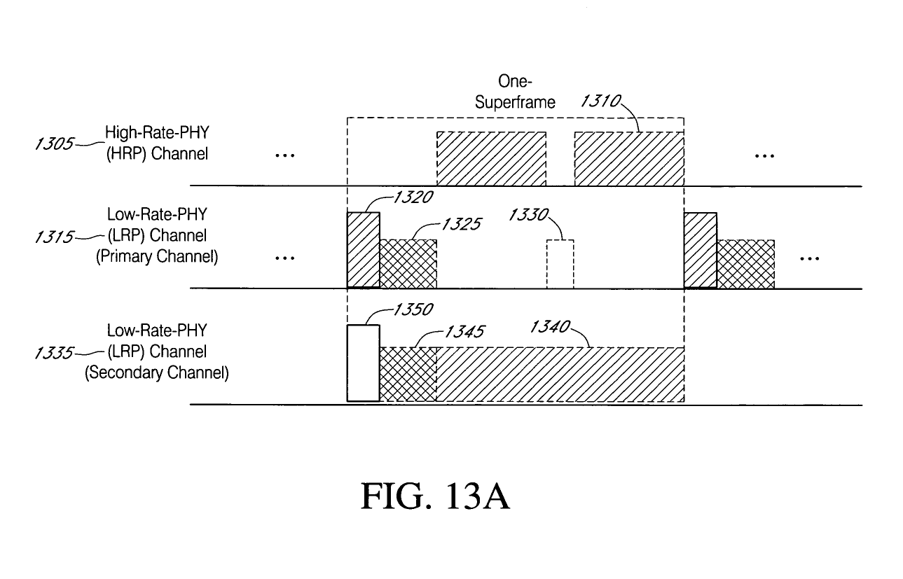

FIG. 11 is a diagram illustrating an embodiment of a data packet 1100 that may be used in a bandwidth response message. The data packet 1100 may be transmitted by the device coordinator 112 at block 830 of the process 800 and received by the device 114 at the block 910 of the process 900 as discussed above. Multiple response data packets 1100 may be combined in a single bandwidth response message. The response data packet 1100 includes a reason code field 1105, a stream index field 1110 and a stream request ID field 1115. The stream request ID field 1115 can be the same as discussed above in reference to the stream request ID field 1020 that was set by the requesting device. In this way, when the device coordinator transmits the response data packet 1100, the requesting device can identify it at decision block 915 of the process 900 as being associated with the previously transmitted bandwidth request message.

The Stream Index field 1110 indicates the stream index assigned by the device coordinator. In a case where a client device is requesting creation of a new isochronous stream, this field is set to an unassigned stream index value by the originating device (e.g., the device coordinator). In a case where a device is requesting the reservation or termination of an asynchronous stream, the stream index field 1110 is set to the existing asynchronous stream value. Certain stream index fields may be reserved so as to indicate the purpose of a stream. For example, reserved stream index values may be used to indicate a stream is one of a management traffic stream, a bandwidth reservation stream, an unassigned stream, or a quiet channel time block (e.g., for current channel assessment).

The reason code field 1105 indicates whether the bandwidth request is granted. The reason code field 1105 is set to one value (e.g., zero) if the bandwidth request was successful, and to another value (e.g., one) if it was not successful. The reason code field may be set to other values to indicate certain failure conditions. As discussed above in reference to the process 900, at the decision block 915, after receiving the bandwidth response message with the reason code indicating a failure condition, the process 900 returns to step 905 where another bandwidth request message may be transmitted depending on the error condition indicated by the reason code field 1105.

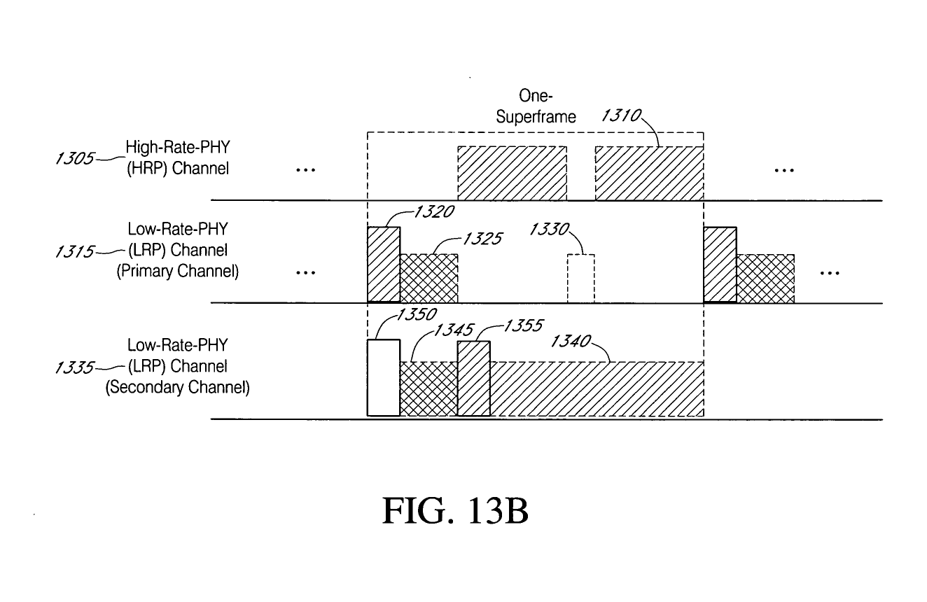

FIG. 12 is a diagram illustrating an embodiment of a data packet that may be used in a bandwidth response message as used in the methods illustrated in FIGS. 8 and 9. The data packet 1200 is a channel index IE (information element) data packet. The channel index IE packet 1200 is transmitted with (either directly with or in a way such that it can be associated with) the data packet 1100 of the bandwidth response message. The channel index IE 1200 includes an element ID field 1210 and a channel index field 1205. The element ID field 1210 contains a value that identifies the data packet 1200 and the associated data packet 1100 (the bandwidth response message) as being elements of a bandwidth response message. The channel index field 1205 identifies which of the channels (e.g., one of the high rate channels 118 or one of the low rate channels 116 shown in FIG. 3B) is to be allocated for communication of the requested stream.

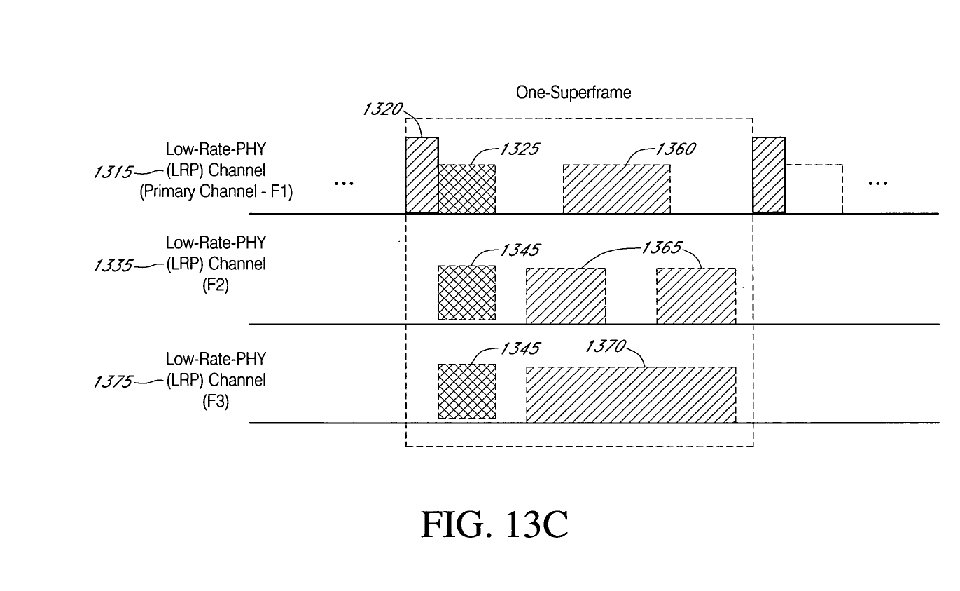

Some examples of bandwidth request assignment on a secondary low rate channel for a requesting device 114 by a device coordinator 112 will now be discussed. FIG. 13a is a diagram illustrating time slot locations of superframe time blocks on a high rate channel, a primary low rate channel and a secondary low rate channel. In this example situation, a high rate channel 1305 is being utilized to communicate uncompressed digital video in two isochronous time blocks 1310 (located in the CTB frame 515 as shown in FIG. 5a. A primary low rate channel 1315 is being utilized to support the beacon frame 1320 and the contention based time period 1325, which is mandatory in this example. The only time remaining to support other communications within the frequency band of the high rate channel 1305 (which overlaps the primary low rate channel 1315) is a small unreserved CTB time slot 1330. If a requesting device transmits a bandwidth request message requesting a larger time slot than is afforded by the unreserved time slot 1330, then the device coordinator selects a secondary low rate channel 1335. In this example the entire CTB frame 515 is reserved for the requesting device as shown by block 1340. The secondary low rate channel 1335 is located within another high rate channel other than the high rate channel 1305. In the example shown, the reserved time block 1340 excludes time blocks 1345 and 1350 that coincide with the contention based time period 1325 and the beacon frame 1320 on the primary low rate channel 1315. Thus, the devices communicating on the secondary low rate channel 1335 can revert to the primary low rate channel 1315 during the beacon frame 1320 and the contention based time period 1325 for purpose of receiving beacon messages and other control messages. In this way, the devices on the secondary low rate channel 1335 may receive or transmit on only one channel at a time, thereby reducing costs. In other embodiments, two or more channels may be received simultaneously, thereby mitigating the need to exclude the time blocks 1345 and 1350.

FIG. 13b is a diagram illustrating another example of time slot locations of superframe time blocks on a high rate channel, a primary low rate channel and a secondary low rate channel as may be used in the methods illustrated in FIGS. 8 and 9. This example situation is similar to the situation illustrated in FIG. 13a, except that the secondary low rate channel 1335 includes its own beacon frame 1355. The beacon frame 1355 is used to synchronize the reserved time block 1340 between devices on the secondary low rate channel 1335. The beacon frame 1320 on the primary low rated channel 1315 is still used to set the timing allocations for the reserved and unreserved CTBs of the primary low rate channel 1315 and the high rate channel 1305. In addition, messages transmitted in the beacon frame 1320 may be use to indicate if any secondary low rate channel (such as 1335 in this example) is currently active. In this example, the reserved time block 1340 excludes time blocks 1350 and 1345 which are aligned with the beacon frame 1320 and contention based time period 1325, respectively.

In the example of FIG. 13b, devices operating on the secondary low rate channel 1335 monitor the beacon frame 1320 on the primary channel. One of the devices operating on the secondary low rate channel 1335 assumes the role of a device coordinator on the secondary low rate channel 1335 and transmits a beacon during the beacon frame 1355 which is time shifted from the beacon frame 1320 on the primary low rate channel. In this manner, the devices operating on the secondary low rate channel 1335 can receive both beacons. In this example, the second beacon frame 1355 carries additional information identifying that this is a secondary network which is temporarily established while the bandwidth is reserved so that new devices do not try to associate on this secondary channel. This beacon frame 1335 may also include information associated with the primary channel so that new devices can easily associate with the coordinator device on the primary low rate channel.

FIG. 13c is a diagram illustrating another example of time slot locations of superframe time blocks on a primary low rate channel and on two secondary low rate channels as may be used in the methods illustrated in FIGS. 8 and 9. In this situation, three low rate channels, the primary low rate channel 1315, the secondary low rate channel 1335 and another secondary channel 1375 are being utilized, where all three low rate channels lie within a single high rate channel. Reserved time block 1360 is being used on the primary low rate channel 1315, while reserved time blocks 1365 and 1370 are used on the secondary low rate channels 1335 and 1375 respectively. The overlapping high rate channel (not shown) may be utilized in any unreserved time slot that is not being utilized by any of the low rate channels 1315, 1335 and 1375. In this example, the beacon frame 1320 on the primary low rate channel 1315 is used to set the timing allocations for the reserved and unreserved CTBs of the primary low rate channel 1315, the secondary low rate channels 1335 and 1375 and the high rate channel (not shown). In the example shown in FIG. 13c, the reserved time blocks 1365 and 1370 exclude time block 1345 that coincides with the contention based time period 1325. In addition time blocks coinciding with the beacon frame 1320 on the primary low rate channel 1315 are also excluded from the reserved time blocks 1365 and 1370 on the secondary channels 1335 and 1375, respectively. Thus, the devices communicating on the secondary low rate channels 1335 and 1375 can revert to the primary low rate channel 1315 during the beacon frame 1320 and the contention based time period 1325 for purpose of receiving beacon messages and other control messages.

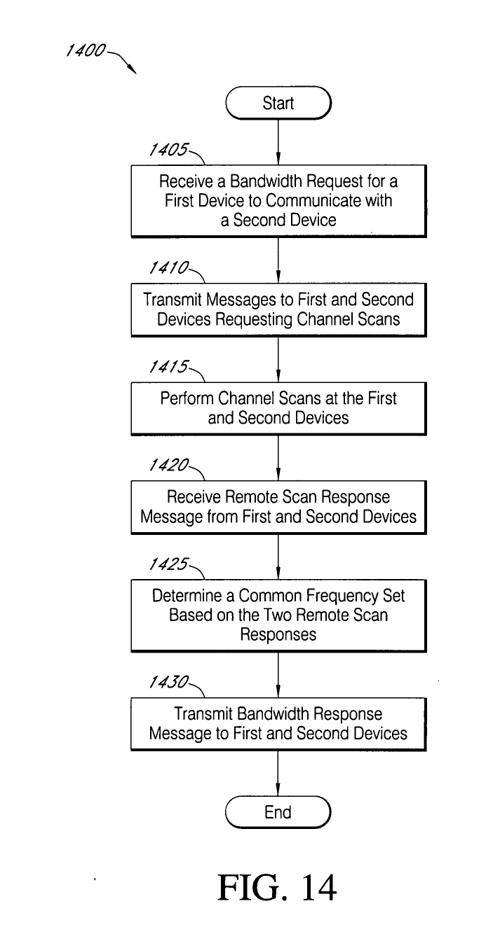

As discussed above, a communication link can be established between two client devices on secondary low rate channels, if it is determined that the two devices are unable to use the high rate channel, which is more efficient. FIG. 14 is a flowchart illustrating an example of another method of performing medium access control in a wireless network such as illustrated in FIG. 1. Process 1400 starts at block 1405 where a device coordinator receives a bandwidth request to establish a communication link between a first device and a second device. The receiver 615 of the device coordinator 600 shown in FIG. 6 can perform the functions of the block 1405.

In this example, the two devices are not able to communicate on the high rate channel. The process 1400 continues at block 1410 where the coordinator device transmits messages to the first and second devices requesting that the first and second devices perform channel scans of the plurality of low rate channels, or a subset of the low rate channels. For example, if the primary low rate channel is being fully or nearly fully utilized, then the subset of channels may include any secondary low rate channels that do not overlap with the high rate channel where the primary low rate channel is located. Alternatively, the device coordinator may request that all the low rate channels are scanned and then determine on its own which subset of low rate channels to choose from. The transmitter 620 of the device coordinator 600 shown in FIG. 6 can perform the functions of the block 1410.

The remote scan request may be similar to that used in the IEEE 802.15.3 standard or other remote scans known to skilled technologists. At block 1415, the first and second devices perform the channels scans of the low rate channels. The remote scans measure a level of noise on the low rate channels which is used as an indication of the channels with the least interference that the two devices can communicate on. The receiver 715 of the device 700 shown in FIG. 7 can perform the functions of block 1415.

The remote scan responses are transmitted by the two devices and received by the device coordinator at block 1420. The remote scan response message from each device typically lists the channels in order from best to worst in terms of interference. The device coordinator then determines, at block 1425, a common frequency from the two low rate channel lists that is highest in quality or lowest in interference. Skilled technologists will know methods of choosing between the two lists in order to determine the common frequency that the two devices can communicate on. The receiver 615 of the device coordinator 600 shown in FIG. 6 can perform the functions of the block 1420. The link control element 625 of the device coordinator 600 shown in FIG. 6 can perform the functions of the block 1425.

After determining the common frequency of the low rate channel to be used for communication between the two devices, the device coordinator transmits bandwidth response messages to the two devices at block 1430. The functions performed at the block 1430 are similar to those performed at the block 830 in the process 800 discussed above in reference to FIG. 8. The bandwidth response messages transmitted at the block 1430 may comprise the data packets 1100 and 1200 as discussed above. The transmitter 620 of the device coordinator 600 shown in FIG. 6 can perform the functions of the block 1430.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. A method of performing link control in a system for wireless communication of uncompressed video, wherein the system comprises a plurality of low rate channels and one or more high rate channels, the method comprising:
receiving a bandwidth request message over a first low rate channel from a first device, the bandwidth request message comprising a minimum bandwidth request; and
selecting one of the low rate channels and determining one or more available time slots on the selected low rate channel that satisfies the minimum bandwidth request if the requesting first device cannot utilize the high rate channel;
wherein the one or more high rate channels are used for communication of uncompressed digital video.

2. The method of claim 1, further comprising determining a capability of the requesting device to utilize the high rate channel.

3. The method of claim 1, further comprising:
reserving the determined time slot on the selected low rate channel; and
transmitting a bandwidth response message identifying the determined time slot and the selected low rate channel.

4. The method of claim 2, wherein the received bandwidth request message further comprises device addresses of the first device and a second device, wherein the bandwidth request message is requesting direct communications between the first device and the second device using the minimum requested bandwidth, the method further comprising:
determining a capability of the second device to utilize the high rate channel; and
in response to determining that either the first or the second device cannot utilize the high rate channel, selecting one of the low rate channels and determining one or more available time slots on the selected low rate channel that satisfies the minimum bandwidth request.

5. The method of claim 4, further comprising:
receiving remote scan response messages from the first device and the second device, wherein the remote scan messages contain information related to the interference level of the low rate channels; and
selecting one of the low rate channels based on the received remote scan response messages.

6. The method of claim 4, wherein the bandwidth request message is received by a first device coordinator; the method comprising:
the first device coordinator transmitting beacon messages during a first reserved time period on the first low rate channel, wherein the first low rate channel is different than the selected low rate channel; and
one of the first or second devices transmitting beacon messages during a second reserved time period on the selected low rate channel, wherein the second reserved time period does not coincide with the first reserved time period.

7. The method of claim 1, further comprising receiving information from the first device identifying a capability of the first device to transmit on the high rate channels or the low rate channels.

8. The method of claim 2, further comprising, in response to determining that the requesting first device can utilize the high rate channel, selecting one of the high rate channels and determining one or more available time slots on the selected high rate channels that satisfies the minimum bandwidth request.

9. The method of claim 1, wherein the one or more determined time slots on the selected low rate channel excludes a time period coinciding with a mandatory contention based time period on the first low rate channel.

10. The method of claim 1, wherein the high rate channel frequency band overlaps the frequency bands of the plurality of low rate channels, and the high rate channel is not utilized for at least a portion of time, the method further comprising:
receiving a plurality of bandwidth request messages over the first low rate channel from a plurality of devices, each of the bandwidth request message comprising a minimum bandwidth request; and
selecting each of the plurality of low rate channels during the portion of time that the high rate channel is not utilized to satisfy the plurality of bandwidth request messages.

11. A system for performing link control in a network for wireless communication of uncompressed video, wherein the network comprises a plurality of low rate channels and one or more high rate channels, the system comprising:
a receiver configured to receive a bandwidth request message over a first low rate channel from a first device, the bandwidth request message comprising a minimum bandwidth request; and
a link controller configured to select one of the low rate channels and determine one or more available time slots on the selected low rate channel that satisfies the minimum bandwidth request if the requesting first device cannot utilize the high rate channel;
wherein the one or more high rate channels are used for communication of uncompressed digital video.

12. The system of claim 11, wherein the link controller is further configured to determine a capability of the requesting device to utilize the high rate channel.

13. The system of claim 11, wherein the link controller is further configured to reserve the determined time slot on the selected low rate channel; and the system further comprises a transmitter to transmit a bandwidth response message identifying the determined time slot and the selected low rate channel.

14. The system of claim 12, wherein the received bandwidth request message further comprises device addresses of the first device and a second device, wherein the bandwidth request message is requesting direct communications between the first device and the second device using the minimum requested bandwidth, wherein the link controller is further configured to determine a capability of the second device to utilize the high rate channel, and in response to determining that either the first or the second device cannot utilize the high rate channel, select one of the low rate channels and determine one or more available time slots on the selected low rate channel that satisfies the minimum bandwidth request.

15. The system of claim 14, wherein the receiver is further configured to receive remote scan response messages from the first device and the second device, wherein the remote scan messages contain information related to the interference level of the low rate channels, and the link controller is further configured to select one of the low rate channels based on the received remote scan response messages.

16. The system of claim 11, wherein the receiver is further configured to receive information from the first device identifying a capability of the first device to transmit on the high rate channel or the low rate channel.

17. The system of claim 12, wherein the link controller is further configured to select one of the high rate channels and determine one or more available time slots on the selected high rate channel that satisfies the minimum bandwidth request, in response to determining that the requesting first device can utilize the high rate channel.

18. The system of claim 11, wherein the one or more determined time slots on the selected low rate channel excludes a time period coinciding with a mandatory contention based time period on the first low rate channel.

19. The system of claim 11, wherein the high rate channel frequency band overlaps the frequency bands of the plurality of low rate channels, and the high rate channel is not utilized for at least a portion of time, the system further comprising:
the receiver further configured to receive a plurality of bandwidth request messages over the first low rate channel from a plurality of devices, each of the bandwidth request message comprising a minimum bandwidth request; and
the link controller further configured to select each of the plurality of low rate channels during the portion of time that the high rate channel is not utilized to satisfy the plurality of bandwidth request messages.

20. A method of performing medium access control in a system for wireless communication of uncompressed video, wherein the system comprises a plurality of low rate channels and one or more high rate channels, the method comprising:
transmitting a bandwidth request message over a first low rate channel, the bandwidth request message comprising a minimum bandwidth request;
receiving a plurality of messages over the first low rate channel wherein one of the received messages is a bandwidth response message associated with the transmitted bandwidth request message, the bandwidth response message containing information identifying a selected low rate channel and at least one reserved time slot within a superframe period, the superframe period being of a predetermined length; and
transmitting and/or receiving over the selected low rate channel during the at least one identified time slot of one or more subsequent superframe periods.

21. The method of claim 20, further comprising determining that one of the received messages is the bandwidth response message associated with the transmitted bandwidth request message.

22. The method of claim 20, wherein the transmitted bandwidth request message further comprises device addresses of a first device and a second device, wherein the bandwidth request message is requesting direct communications between the first device and the second device using the minimum requested bandwidth.

23. The method of claim 20, further comprising:
scanning the plurality of low rate channels to measure the interference on each of the plurality of low rate channels; and
transmitting a scan response message containing information related to the measured interference.

24. The method of claim 20, wherein the selected low rate channel is the first low rate channel.

25. The method of claim 20, wherein a frequency band of each of the plurality of low rate channels overlaps a frequency band of one of the high rate channels.

26. The method of claim 20, further comprising transmitting information identifying a capability of a first device to transmit on the high rate channel or the low rate channel.

27. A system for performing medium access control in a network for wireless communication of uncompressed video, wherein the network comprises a plurality of low rate channels and one or more high rate channels, the system comprising:
a transmitter to transmit a bandwidth request message over a first low rate channel, the bandwidth request message comprising a minimum bandwidth request; and
a receiver to receive a plurality of messages over the first low rate channel, wherein one of the received messages is a bandwidth response message associated with the transmitted bandwidth request message, the bandwidth response message containing information identifying a selected low rate channel and at least one reserved time slot within a superframe period, the superframe period being of a predetermined length;
wherein, the transmitter transmits and/or the receiver receives over the selected low rate channel during the at least one identified time slot of one or more subsequent superframe periods.

28. The method of claim 27, further comprising a medium access controller configured to determine that one of the received messages is the bandwidth response message associated with the transmitted bandwidth request message

29. The system of claim 27, wherein the transmitted bandwidth request message further comprises device addresses of a first device and a second device, wherein the bandwidth request message is requesting direct communications between the first device and the second device using the minimum requested bandwidth.

30. The system of claim 27, wherein the receiver is further configured to scan the plurality of low rate channels to measure the interference on each of the plurality of low rate channels, and the transmitter is further configured to transmit a scan response message containing information related to the measured interference.

31. The system of claim 27, wherein the selected low rate channel is the first low rate channel.

32. The system of claim 27, wherein a frequency band of each of the plurality of low rate channels overlaps a frequency band of one of the high rate channels.

33. The system of claim 27, wherein the transmitter is further configured to transmit information identifying a capability of a first device to transmit on the high rate channel or the low rate channel.

34. A system for wireless communication of uncompressed digital video data over a wireless communication link, the wireless communication link including one or more high rate channels associated with a bandwidth capable of supporting transmission of the uncompressed video data, and a plurality of low rate channels comprising second bandwidths smaller than the first bandwidth, wherein at least a portion of a frequency band of each of the low rate channels overlaps a portion of a frequency band of one of the high rate channels, the system comprising:
a device coordinator comprising:
a receiver to receive a request for an available bandwidth over the low rate channel,
a medium access controller configured to determine a capability to utilize the high rate channel, and, in response to determining that the high rate channel cannot be utilized, select one of the low rate channels and determine a time slot available on the selected low rate channel that satisfies the bandwidth request, and
a transmitter to transmit a response message over the low rate channel containing information identifying the determined time slot and the low rate channel; and
a device comprising:
a transmitter to transmit the request for an available bandwidth over the low rate channel, and
a receiver to monitor the low rate channel and to receive the response message,
wherein the transmitter is further configured to transmit on the low rate channel during the identified time slot.
